(19) United States
(12) Patent Application Publication
(10) Pub. No.: US 2002/0097812 A1
(43) Pub. Date: Jul. 25, 2002

(54) In-phase and quadrature-phase rebalancer

(76) Inventor: John Wiss, Sunnyvale, CA (US)

Correspondence Address: Thomas J. Tighe, Esq., 6265 Greenwich Drive, Suite 103, San Diego, CA, 92122, US

(21) Appl. No.: 09/727,993

(22) Filed: Dec. 1, 2000

(51) Int. Cl. H04L 27/08; H04L 27/22; H04L 27/14; H04L 27/06

(52) U.S. Cl. 375/316

(57) ABSTRACT

A first variable gain function is in series with an unbalanced in-phase component, and a circuit loop produces a first error signal which varies the first gain function such that its output is a signal which continuously converges toward a balanced in-phase component. A second variable gain function receives as input the unbalanced in-phase component, and a summing function in series with the unbalanced quadrature component algebraically adds the unbalanced quadrature component and the output of the second gain function. A second circuit loop produces a second error signal which varies the second gain function such that the output of the summing function is a signal which continuously converges toward a balanced quadrature component. Preferably the first error signal is produced by respectively squaring the outputs of the first gain function and the summing function, finding the difference of the squares, multiplying the difference of the squares by a selected convergence parameter, and continuously integrating the multiplied difference. Preferably the second error signal is produced by multiplying the outputs of the first gain function and the summing function, multiplying the product of the first gain function and the summing function by a selected convergence parameter, and continuously integrating the output of the multiplier. Also preferably the error signal loops are each normalized. Optionally, an initial set of convergence parameters can be applied to speed-up the start of convergence, and a second set of smaller values can be applied some time later for more precise convergence.

This invention relates in general to radio receivers with a zero Hertz final IF (intermediate frequency), e.g. direct downconversion (“zero IF”) receivers, and in particular to a method and apparatus, in such a receiver, for rebalancing in the digital domain the I and Q (in-phase and quadrature-phase respectively) components of an incoming signal.

### BACKGROUND

FIG. 1 shows a direct downconversion receiver in which the I and Q components, 2 and 4, of an incoming signal 6 are conventionally detected by mixing an IF signal 8 with respective sinusoidal references, the I channel being mixed with a reference F_{RF} and the Q channel being mixed with F_{RF} phased shifted minus ninety degrees (−90°), the output of each mixer being lowpass filtered and amplified by an automatic gain control circuit AGC and then digitized. The problems addressed by this invention occur because conventional −90° phase shifters are not precisely balanced causing phase imbalance, and the AGC amplifiers are not perfectly matched causing a gain imbalance.

FIGS. 2 and 3 show uncoded BER (bit error rate) performance for various levels of phase, gain, and combined gain and phase imbalance for a 64 QAM-OFDM signal per IEEE 802.11A. There is an implied implementation loss of about 1 dB and the curves reflect the performance in an additive white Gaussian noise channel (AWGN). No digital compensation algorithm is used for these curves. FIG. 2 shows the effect on the BER performance with a phase imbalance. There is no assumed gain imbalance between the I and Q channels for this plot. At an uncoded BER of 10⁻⁴ the losses for the following phase imbalance loss can be noted:

For 1 degree of imbalance there is an additional loss of 0.15 dB.

For 2 degrees of imbalance there is an additional loss of 0.5 dB.

For 3 degrees of imbalance there is an additional loss of 1.0 dB.

Clearly the loss values will be higher when including a gain imbalance and a phase imbalance effect. FIG. 3 shows the effect of a gain imbalance on BER performance. There is no assumed phase imbalance between the I and Q channels for this plot. At an uncoded BER of 1 E−4 the losses for the following gain imbalance losses can be noted:

For 0.2 dB (about 2.3%) of imbalance, there is an additional loss of 0.05 dB.

For 0.4 dB (about 4.7%) of imbalance there is an additional loss of 0.25 dB.

For 0.5 dB (about 5.9%) of imbalance there is an additional loss of 0.5 dB.

For 0.7 dB (about 8.4%) of imbalance there is an additional loss of 1.0 dB.

The above-described imbalances occur in a system that has a zero IF final frequency with analog I and Q channels. As a rule of thumb, keeping the gain imbalance below 0.4 dB and phase imbalance below 3 degrees will result in a maximum performance loss of approximately 1 dB for an IEEE 802.11A system with 64 QAM-ODFM.

This invention provides compensation techniques to mitigate the effects of I/Q imbalance for zero IF receivers, i.e., a means and method for rebalancing the I and Q (in-phase and quadrature-phase, respectively) components of an incoming signal. This invention provides a fully digital, nonlinear adaptive rebalancer which requires no tone insertion, and is independent of the modulation employed by the system, and the adaptive performance of which is excellent even at low SNR (signal-to-noise ratio). This rebalancer will operate on a wide class of signals using a novel blind approach, i.e., without any a priori knowledge of the characteristics of an incoming signal, and does not require calibration using a known test tone.

Other advantages and attributes of this invention will be seen from a reading of the text hereinafter.

### SUMMARY OF THE INVENTION

It is an object of this invention to provide compensation techniques to mitigate the effects of I/Q imbalance for zero IF receivers, i.e., a means and method for rebalancing the I and Q (in-phase and quadrature-phase, respectively) components of an incoming signal.

It is a further object of this invention to provide such compensation which requires no tone insertion, and is independent of the modulation employed by the system, and the adaptive performance of which is excellent even at low SNR.

It is a further object of this invention to provide an I and Q rebalancer which will operate on a wide class of signals using a novel blind approach, i.e., without any a priori knowledge of the characteristics of an incoming signal, and does not require calibration using a known test tone.

It is a further object of this invention to provide for zero IF receivers a continuously adaptive device for rebalancing quantized in-phase and quadrature phase components of a received signal.

These and other objects, expressed or implied hereinafter, are accomplished by a continuously adaptive device for rebalancing quantized in-phase and quadrature phase components of a received signal which includes: (1) a first variable gain function in series with the unbalanced in-phase component; (2) a circuit for varying the first gain function such that its output is a signal which continuously converges toward a balanced in-phase component; (3) a second variable gain function which receives as input the unbalanced in-phase component; (4) a summing function in series with the unbalanced quadrature component which algebraically adds the unbalanced quadrature component and the output of the second gain function; and (5) a second circuit for varying the gain of the second gain function such that the output of the summing function is a signal which continuously converges toward a balanced quadrature component. Preferably the first gain function varies according to a first error signal, and the first error signal is produced by respectively squaring the outputs of the first gain function and the summing function, finding the difference of the squares, multiplying the difference of the squares by a selected convergence parameter, and continuously integrating the multiplied difference to produce the first error signal. Preferably the second gain function varies according to a second error signal, and the second error signal is produced by multiplying the outputs of the first gain function and the summing function, multiplying the product of the first gain function and the summing function by a selected convergence parameter, and continuously integrating the output of the multiplier to produce the second error signal. Also preferably the difference of the squares, and the product of the outputs of the first gain function and the summing function are each normalized. Optionally two sets of convergence parameters can be used: an initial set to speed-up the start of convergence, and a second set some time later for more precise convergence.

### DESCRIPTION OF THE DRAWINGS

FIG. 1 is a functional diagram of a first prior art receiver.

FIG. 2 is a chart of typical phase imbalances correctable by this invention.

FIG. 3 is a chart of typical gain imbalances correctable by this invention.

FIG. 4 is a functional diagram of a second prior art receiver using a conventional “test tone” technique for compensating for imbalance.

FIG. 5 is a functional diagram of a receiver incorporating this invention.

FIGS. 6 and 7 illustrate convergence properties of an apparatus according to this invention.

FIGS. 8 through 10 illustrate the steady state jitter statistics of an apparatus according to this invention.

### DESCRIPTION OF THE PREFERRED EMBODIMENT

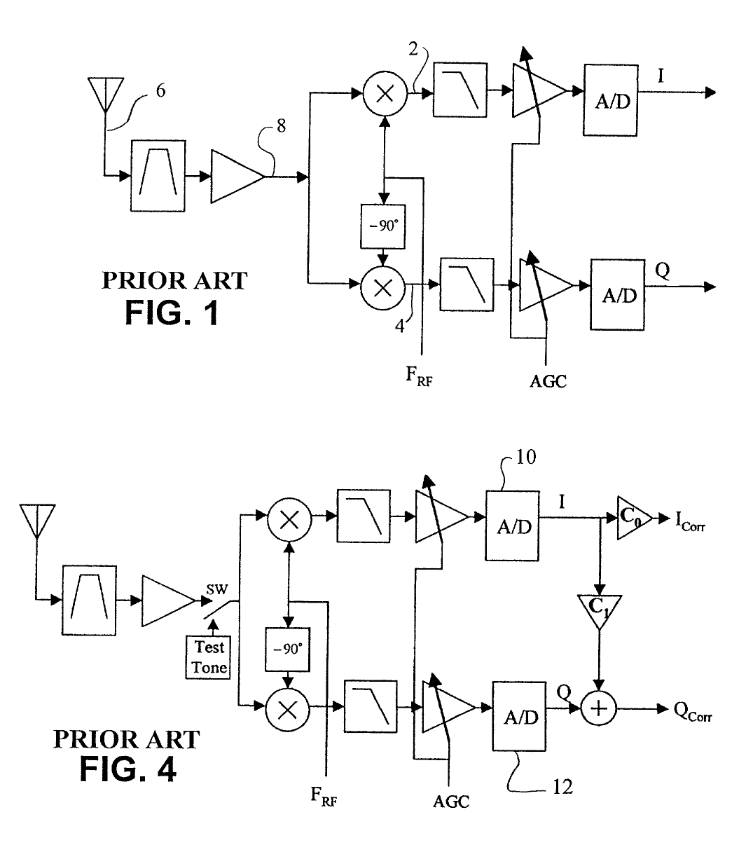

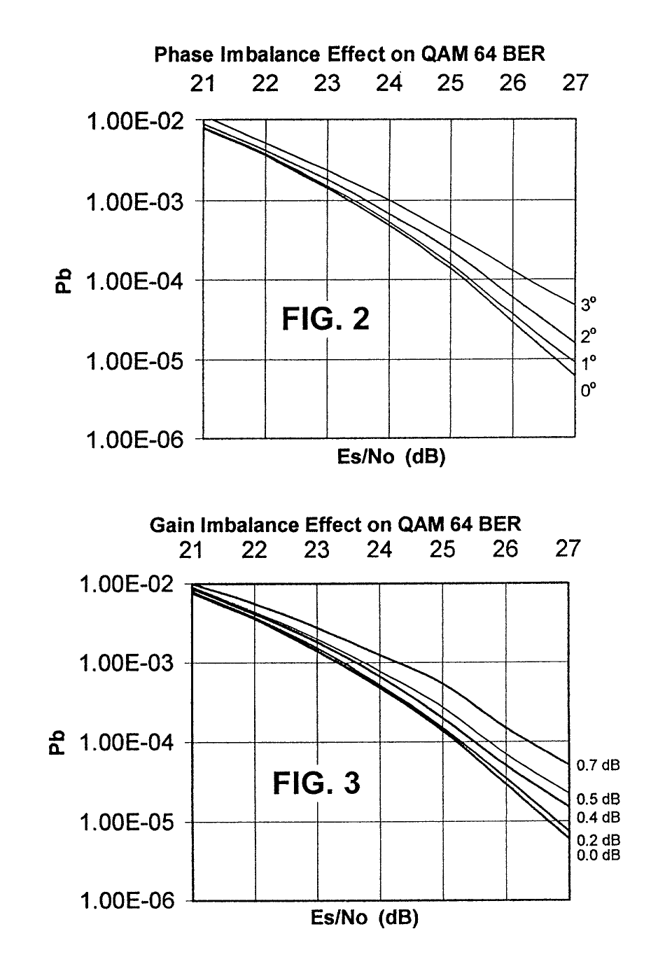

A model for the effect of gain and phase imbalance can be the following matrix equation:

$$[ \begin{matrix}{I}_{IMB} \\ {Q}_{IMB}\end{matrix} ] = [ \begin{matrix}1 + α & 0 \\ sin φ & cos φ\end{matrix} ] [ \begin{matrix}I \\ Q\end{matrix} ] \qquad ( 1 )$$

Where the gain and phase imbalance values are given by α and Φ respectively. In this treatment the gain imbalance is assumed to be present on the I channel and the phase imbalance is assumed to be present on the Q channel. The inverse of (1) is given by:

$$[ \begin{matrix}{I}_{Corr} \\ {Q}_{Corr}\end{matrix} ] = \frac{1}{cos φ} [ \begin{matrix}\frac{cos φ}{1 + α} & 0 \\ - \frac{sin φ}{1 + α} & 1\end{matrix} ] [ \begin{matrix}{I}_{IMB} \\ {Q}_{IMB}\end{matrix} ] \qquad ( 2 )$$

Where the Corr subscript denotes the (digitally) corrected I and Q channels. FIG. 1 illustrates a basic structure of a receiver including the I/Q rebalancing circuit. From this it can be seen that only two real parameters are needed

$${C}_{0} = \frac{cos φ}{1 + α}$$

and

$${C}_{1} = \frac{- sin φ}{1 + α}$$

in the digital domain to rebalance the signal.

A prior art approach, explained below, uses a test tone to perform the I/Q rebalancing, whereas this invention uses a new technique that involves adaptive filtering.

Referring to FIG. 4 a prior art receiver with digital I/Q rebalancing is illustrated. This technique uses a calibration tone, and is based on estimating the constants α and Φ based on observations made from a single tone which is generated in the receiver chain specifically for this purpose. The tone must be generated with a frequency equal to ¼ of the sampling rate of the system when referenced to baseband. Thus for a pair of I and Q analog-to-digital (“A/D”) converters, 10 and 12, operating at a 20 MHz sampling rate, a reference tone should be placed at 5 MHz at the point in the receiver chain prior to the analog I/Q split operation. For a single-stage direct to DC receiver, the tone must be injected at a 5 MHz offset relative to the channel center frequency such that after mixing to baseband and filtering, a pure tone will appear at

$$+ \frac{{F}_{Samp}}{4} .$$

The tone should be at this frequency to simplify computation of the gain and phase imbalance.

A testing tone at

$$+ \frac{{F}_{Samp}}{4}$$

will, upon sampling the signal at the I and Q channel A/D converters, be equal to:

$$s ( k ) = ( 1 + α ) cos ( \frac{π}{2} k + ψ ) + a + j [ sin ( \frac{π}{2} k + ψ + φ ) + b ] \qquad ( 3 )$$

Where: ψ is an arbitrary signal phase, and

a+jb is the DC offset.

Over one cycle of the test tone as referenced to baseband, the following samples (4 per period) will be output from the A/Ds where the signal is abbreviated in complex notation to be equal to s(t)=I(t)30 jQ(t). Arbitrarily setting the nominal amplitude of the signal to unity, after four sampling periods there are the following:

s(0)=(1+α) cos ψ+a+j[ sin (ψ+Φ)+b]

s(1)=−(1+α) sin ψ+a+j[ cos (ψ+Φ)+b]

s(2)=−(1+α) cos ψ+a+j[−sin (ψ+Φ)+b]

s(3)=(1+α) sin ψ+a+j[−cos (ψ+Φ)+b] (4)

Where: a+jb represents a possible DC offset in the receiver. Information that can be used to extract the DC offset, cancel the arbitrary signal received phase ψ, the gain imbalance α, and the phase imbalance Φ involves extraction of parameters related to the amplitude and phase of the fundamental signal and image of the test tone. Thus the FFT block in the receiver can be used to estimate and then correct the imbalances. If the input is a +5 MHz tone and the receiver has a 64 point FFT which has an input sample rate of 20 MHz, there will be seen a significant output of the fundamental at the FFT bin corresponding to 5 MHz which will be bin 16. Due to leakage of the non-orthogonal portion of the complex signal there will be energy in the bin corresponding to −5 MHz or bin 48 because in a sense a small real signal has been created which must have a symmetric spectrum about zero. After one FFT period (3.2 microseconds) the output of the fundamental in bin 16 can be computed as follows:

FFT(16)=2K[(1+α)+cos Φ+j sin Φ]exp(jψ)

FFT(48)=2K[(1+α)−cos Φ+j sin Φ]exp(−jψ) (5)

which can be determined by evaluating:

$$FFT ( 16 ) = s ( 0 ) + s ( 1 ) exp ( - j \frac{π}{2} ) + s ( 2 ) exp ( - jπ ) + s ( 3 ) exp ( + j \frac{π}{2} ) \\ FFT ( 48 ) = s ( 0 ) + s ( 1 ) exp ( + j \frac{π}{2} ) + s ( 2 ) exp ( - jπ ) + s ( 3 ) exp ( - j \frac{π}{2} ) \\ Simplifying yields \text{:} \qquad ( 6 )$$

Simplifying yields:

FFT(16)=s(0)−s(2)−js(1)+js(3)

FFT(48)=s(0)−s(2)+js(1)−js(3) (6)

Where the s( ) values are from (4). The fact that 16 complete periods of the test tone are observed simply scales the results above by a constant but yields the same result if one period were observed (4 input samples) and a 4-point DFT was taken. The simple factors of j that multiply some of the terms result from the oversampling by 4. Taking the following simple function of the FFT outputs:

FFT*(16)+FFT(48)=4K(1+α)exp(−jψ) (7)

the ratio

$$R = \frac{2 \cdot FFT ( 48 )}{FFT * ( 16 ) + FFT ( 48 )} can be formed to obtain \text{:} \\ R = 1 - \frac{cos φ}{( 1 + α )} + j sin \frac{φ}{( 1 + α )} = 1 - {C}_{0} + j {C}_{1} \qquad ( 8 )$$

and finally:

1−Re(R)=C₀

and

−Im(R)=C₁. (9)

Thus once R has been constructed, C₀ and C₁ are deduced from the real and imaginary parts to apply to the rebalancing circuit of FIG. 4. The major disadvantage of this system is that a tone generation circuit (and switch) must be included in the receiver design, and the correction must be made while not taking data.

In contrast, this invention provides a fully adaptive approach that requires no additional circuitry in the radio and is based on a novel set of nonlinear error metrics that provide extremely robust and accurate adaptive filtering to cancel the phase and gain imbalance in the receiver. This invention is blind in the sense that no carrier phase recovery is required. In fact, no a priori knowledge of the incoming signal is necessary for rebalancing, e.g. noise is an acceptable signal for rebalancing.

Heretofore blind equalization techniques have been based on the Godard version of a constant modulus algorithm which can be found in such texts as Haykin, Simon, Adaptive Filter Theory, 3rd Ed., Upper Saddle River N.J., Prentice Hall 1996 (see pages 791-795). The constant modulus algorithm uses a cost function that is related to the deviation of a signal from a constant modulus Rₚ with a function type

$$J = {\vert I \vert}^{2} + {\vert Q \vert}^{2} - {R}_{p}^{2}$$

that is then used in a gradient equalization algorithm. However in this invention the Godard cost function approach is not used, but rather a new set of metrics are used in the rebalancing equalizer which are based on very simple functions of the unbalanced data. The new error metrics are:

ε_{α}=<I_{Corr}²−Q_{Corr}²>

ε_{Φ=<}I_{Corr}·Q_{Corr}> (10)

Where the angled brackets denote the time average of the quantities contained within. The metric ε_{α} is zero when the gain imbalance is zero (assuming the absence of a phase imbalance, Φ=0). The value of ε_{α} in the presence of a gain imbalance is related to the amount of imbalance on the I channel relative to the Q channel out of the rebalancer circuit. In the absence of a phase imbalance it is obvious that ε_{α} is a measure of the power mismatch (1+α)² between the I and Q channels. The stationery point for ε_{α} when the error term is near zero can be determined as follows:

$${ϵ}_{α} = \frac{( 1 - {tan}^{2} φ ) ⟨ {I}_{IMB}^{2} ⟩}{{( 1 + α )}^{2}} + \frac{2 ⟨ {I}_{IMB} {Q}_{IMB} ⟩ tan φ}{( 1 + α ) cos φ} - \frac{⟨ {Q}_{IMB}^{2} ⟩}{{cos}^{2} φ} \qquad ( 11 )$$

A common denominator is found and the numerator is set to zero:

$${ϵ}_{α} = 0 = \frac{( 1 - {tan}^{2} φ ) {cos}^{2} φ ⟨ {I}_{IMB}^{2} ⟩ + 2 ⟨ {I}_{IMB} {Q}_{IMB} ⟩ sin φ ( 1 + α ) - ⟨ {Q}_{IMB}^{2} ⟩ {( 1 + α )}^{2}}{{cos}^{2} {φ ( 1 + α )}^{2}} \qquad ( 12 )$$

Thus setting the numerator to zero, letting a=(1+α) which is equal to the correction factor for perfect gain balance with Φ=0, and solving the quadratic equation in a:

$$a = \frac{- 2 ⟨ {I}_{IMB} {Q}_{IMB} ⟩ sin φ \pm \sqrt{4 {( ⟨ {I}_{IMB} {Q}_{IMB} ⟩ )}^{2} {sin}^{2} φ + 4 ⟨ {I}_{IMB}^{2} ⟩ ⟨ {Q}_{IMB}^{2} ⟩ ( 1 - 2 {sin}^{2} φ )}}{- 2 ⟨ {Q}_{IMB}^{2} ⟩} \qquad ( 13 )$$

$$a = \frac{- 2 ⟨ {I}_{IMB} {Q}_{IMB} ⟩ sin φ \pm \sqrt{4 ( {sin}^{2} φ ) ( {⟨ {I}_{IMB} {Q}_{IMB} ⟩}^{2} - 2 ⟨ {I}_{IMB}^{2} ⟩ ⟨ {Q}_{IMB}^{2} ⟩ ) + 4 ⟨ {I}_{IMB}^{2} ⟩ ⟨ {Q}_{IMB}^{2} ⟩}}{- 2 ⟨ {Q}_{IMB}^{2} ⟩} \qquad ( 14 )$$

Note that in the case of very small X the first term and the first term under the radical can almost be neglected to show that

$$a ≅ \frac{\sqrt{⟨ {I}_{IMB}^{2} ⟩}}{\sqrt{⟨ {Q}_{IMB}^{2} ⟩}}$$

which is precisely the factor by which to multiply the Q branch to account for the gain mismatch between I and Q. Determining a iteratively will generate an error that is equal to the gain imbalance. In the presence of a phase imbalance, ε_{Φ} is an average cross correlation of the I and Q channels after the rebalancer. In the presence of a phase imbalance only, it can be assumed that the correction coefficients are nominal and take the expected value E(·):

E(I_{IMB}·Q_{IMB})=sin Φ·E(I²)+cos Φ·E(IQ_{cos Φ}) (15)

For random data on I and Q, the second expectation will vanish when averaged sufficiently for a wide class of signals, thus producing a metric that is minimum about the point Φ=0 with a zero crossing located at that point. The stationary point for co when the error term is zero can be determined as follows:

$${ϵ}_{φ} = 0 = \frac{- tan φ ⟨ {I}_{IMB}^{2} ⟩}{{( 1 + α )}^{2}} + \frac{⟨ {I}_{IMB} {Q}_{IMB} ⟩}{( 1 + α ) cos φ} \qquad ( 16 )$$

Solving for phase imbalance Φ:

$$φ = {sin}^{- 1} ( \frac{⟨ {I}_{IMB} {Q}_{IMB} ⟩ ( 1 + α )}{⟨ {I}_{IMB}^{2} ⟩} ) \qquad ( 17 )$$

This shows that when the phase imbalance is zero, the time average <I_{IMB}Q_{IMB}> must be zero. This proves that the signal projection on the I axis must be orthogonal to the signal on the Q axis such that no component projects to the other axis.

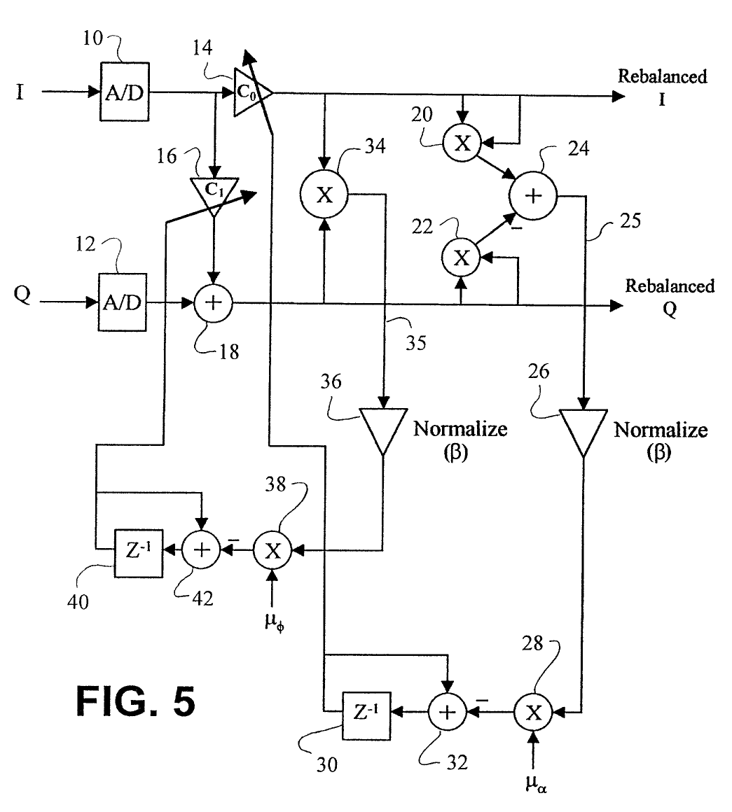

Referring to FIG. 5, a preferred embodiment of this invention is illustrated. The I and Q components of an incoming signal are each digitized by respective A/D converters, 10 and 12. The digitized I component is then amplified, i.e., multiplied by a circuit 14 having a variable coefficient C₀, the coefficient being a function of a gain imbalance loop described below, the output of circuit 14 being a rebalanced I. The digitized I component is also multiplied by a circuit 16 having a variable coefficient C₁, the coefficient being a function of a phase imbalance loop described below. The output of circuit 16 is added to the digitized Q component by adder 18, the sum being a rebalanced Q. The gain imbalance loop begins with two multipliers, 20 and 22, the first squaring the output of circuit 14 and the second squaring the output of the adder 18. The output of multiplier 22 is subtracted from the output of multiplier 20 by a summing function 24 the output 25 of which is proportional to error metric ε_{α}. The output 25 is normalized (by a normalization function 26) and subsequently multiplied by a convergence factor μ_{α} (by multiplier 28). The output of 28 is then digitally integrated by a register 30 and a summing function 32 configured as a digital accumulator, the output of the accumulator being at any given time the coefficient C₀. The phase imbalance loop begins with a multiplier 34 which multiplies the output of circuit 14 with the output of the adder 18. The output 35 of the multiplier 34, which is proportional to the error metric ε_{Φ}, is then normalized (by a normalization function 36) and subsequently multiplied by a convergence factor μ_{Φ} (by multiplier 38). The output of 38 is then digitally integrated by a register 40 and a summing function 42 configured as a digital accumulator, the output of the accumulator being at any given time the coefficient C₁.

Referring again to FIG. 5, the two “Normalize” functions, 26 and 36, are preferable but not necessary in all cases. They account for signal level fluctuations into the receiver. These functions have the effect of ensuring constant adaptation behavior regardless of input signal level. For a given system these blocks may be set to a constant less than unity.

Determining the phase imbalance Φ iteratively will generate an error that is proportional to, and in the direction of, Φ in order to eventually decorrelate the signals on I and Q. The effect of the parameter α merely changes the error magnitude and since practical values for α are small (|α|≦0.1) the convergence of the parameter C₁ to its optimal value is largely independent of the value of the gain imbalance α. Thus the convergences of C₀ and C₁ to their optimal values are largely independent of each other and the initial values of α and Φ. The process, illustrated in FIG. 5, is made iterative by integrating the error metrics ε_{α} and ε_{Φ} (normalized digital signals 25 and 35 respectively) and applying the convergence parameters μ_{α} and μ_{Φ} prior to integration (at 28 and 38), e.g. as in a Least Mean Square (LMS) type process. Conventional implementation of an LMS based tracking loop uses a single convergence value for all the parameters, but note that in FIG. 5 the two convergence parameters, μ_{α} and μ_{Φ}, are illustrated to independently control the convergence of the filter coefficients C₀ and C₁:

C₀(k)=C₀(k−1)−μ_{α}(I²−Q²)·β

C₁(k)=C₁(k−1)−μ_{Φ}(I·Q)·β

where k is a function of time and β=a normalization constant.

The convergence parameters must be selected small enough to satisfy two requirements: first, μ_{α} and μ_{Φ} must be small enough to allow the digital accumulator to sufficiently time-average the error metrics ε_{α} and ε_{Φ}, and second, to ensure acceptable steady-state performance of the rebalancer. Preferably, μ_{α} and μ_{Φ} are determined experimentally via simulation to ensure proper selection of the convergence parameters under the conditions of interest. In order to speed up the convergence of the rebalancer, one set of convergence parameters can be applied initially (μ_{α}(init) and μ_{Φ}(init)) and then a smaller set of convergence parameters applied some time later (μ_{α}(final) and μ_{Φ}(final)).

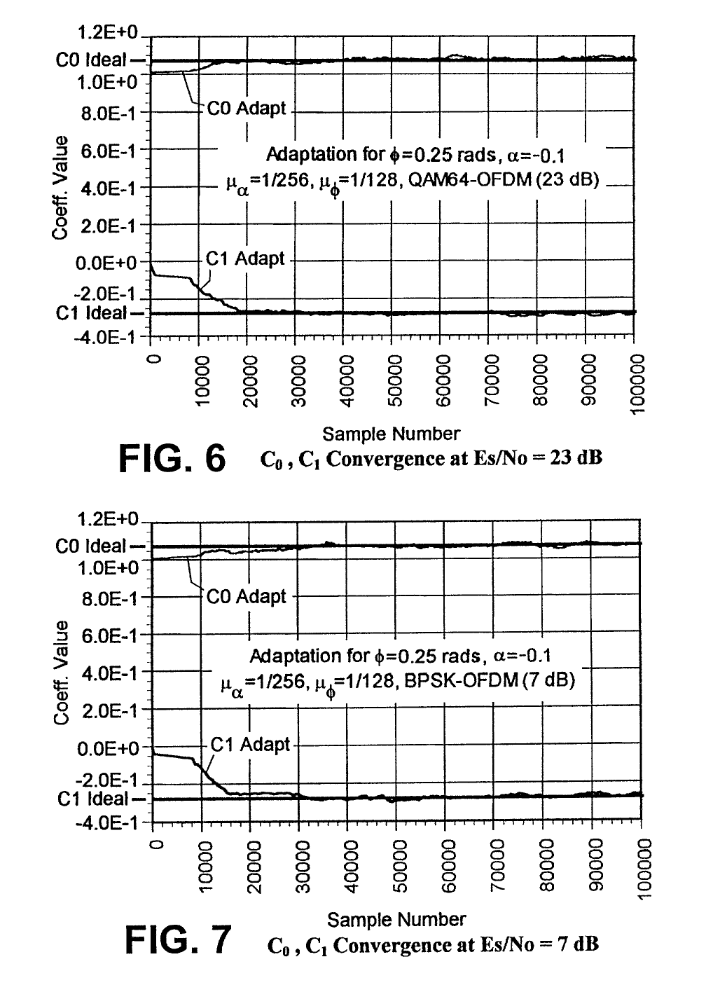

Referring to FIGS. 6 and 7, illustrated are the convergence properties of this inventive process at various SNRs for a IEEE 802.11A compliant multicarrier system. FIG. 6 shows convergence of the coefficients C₀ and C₁ respectively where the signal is normalized by its average power (a constant=RMS signal power) and ε_{α}=−0.1, ε_{Φ}=0.25 (a −10% gain imbalance and a 14° phase imbalance). In this embodiment the convergence parameter μ_{α}(init) was preferably set equal to 1/256 and μ_{Φ}(init) was preferably set equal to 1/128. After 52 samples the convergence parameters were reduced by a factor of 32, thus μ_{α}(final)=1.22×10⁻⁴ and μ_{Φ}(final)=2.44×10⁻⁴ and the Es/No=23 dB, a nominal point for QAM−64 OFDM. It should be noted that convergence was accomplished in approximately 20,000 samples for C₀ and C₁. This shows that from a cold start, assuming a 20 MHz A/D sampling rate, the rebalancer of this invention can be fully adapted in 0.001 seconds. FIG. 7 shows the characteristics for a lower SNR (7 dB). There is not much difference in the convergence characteristic for the two coefficients C₀ and C₁ for low versus high SNR. The rebalancer can also track variations in the imbalance easily.

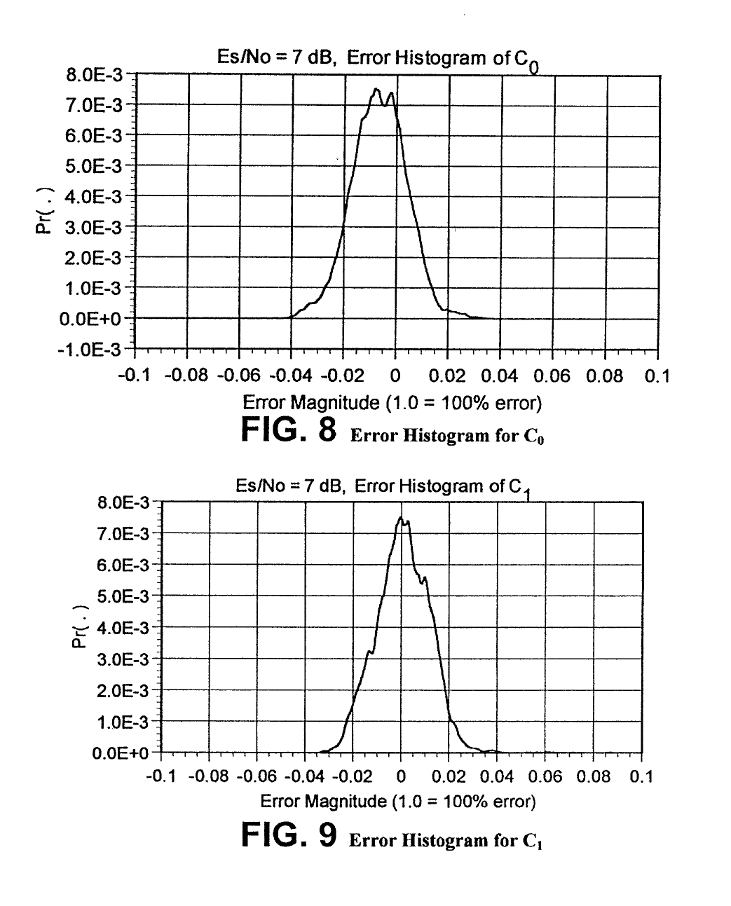

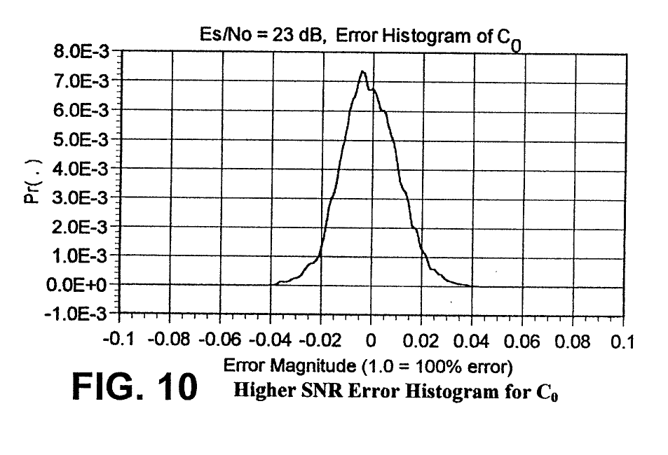

FIGS. 8 and 9 show the steady state jitter statistics of C₀ and C₁, respectively. It should be noted that at Es/No =7 db the RMS jitter is approximately 1% for both coefficients. This jitter will cause no observable degradation in BER performance. It should also be noted that there is a slight bias in the coefficient C₀ (about ¼%) which has no measurable impact on performance and decreases with SNR. This bias approaches zero as the signal power increases as can be seen in FIG. 10.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims.

I claim:

1. A continuously adaptive device for rebalancing quantized in-phase and quadrature phase components of a received signal comprising:
(a) a first variable gain function in series with the unbalanced in-phase component;
(b) means for varying the first gain function such that its output is a signal which continuously converges toward a balanced in-phase component;
(c) a second variable gain function which receives as input the unbalanced in-phase component;
(d) a summing function in series with the unbalanced quadrature component which algebraically adds the unbalanced quadrature component and the output of the second gain function; and
(e) means for varying the gain of the second gain function such that the output of the summing function is a signal which continuously converges toward a balanced quadrature component.

2. The device according to claim 1 wherein:
(a) the first gain function varies according to a first error signal, the first error signal being produced by a loop comprising:
(1) means for respectively squaring the outputs of the first gain function and the summing function,
(2) means for finding the difference of the squares,
(3) means for multiplying the difference of the squares by a selected convergence parameter, and
(4) means for continuously integrating the multiplied difference; and
(b) the second gain function varies according to a second error signal, the second error signal being produced by a loop comprising:
(1) means for multiplying the outputs of the first gain function and the summing function,
(2) a multiplier for multiplying the product of the first gain function and the summing function by a selected convergence parameter, and
(3) means for continuously integrating the output of the multiplier.

3. The device according to claim 2 wherein the difference of the squares, and the product of the outputs of the first gain function and the summing function are each normalized.

4. The device according to claim 2 wherein the two convergence parameters have different values.

5. The device according to claim 2 further comprising a first set of selected convergence parameters which are applied initially to speed-up convergence, and a second set of convergence parameters which are applied some time later for more precise convergence.

6. A method of adaptively rebalancing quantized in-phase and quadrature phase components of a received signal comprising the steps:
(a) multiplying the unbalanced in-phase component with a first variable coefficient to produce a first product;
(b) varying the first coefficient such that the first product is a signal which continuously converges toward a balanced in-phase component;
(c) multiplying the unbalanced in-phase component with a second variable coefficient to produce a second product;
(d) summing the unbalanced quadrature component and the second product to produce a first sum; and
(e) varying the second coefficient such that the first sum is a signal which continuously converges toward a balanced quadrature component.

7. The method according to claim 6 wherein:
(a) the step of varying the first coefficient comprises the steps:
(1) respectively squaring the first product and the first sum;
(2) finding the difference of the two squares;
(3) multiplying the difference of the two squares by a selected convergence parameter, and
(4) continuously integrating of the multiplied difference; and
(b) the step of varying the second coefficient comprises the steps:
(1) multiplying the first product and the first sum to produce a second product,
(2) multiplying the second product by a selected convergence parameter, and
(3) continuously integrating of the multiplied second product.

8. The method according to claim 7 further comprising the steps:
(a) applying a first set of selected convergence parameters initially to speed-up convergence, and
(b) applying a second set of convergence parameters some time later for more precise convergence.
